(19) United States
(12) Patent Application Publication
(10) Pub. No.: US 2010/0297468 A1
(43) Pub. Date: Nov. 25, 2010

(54) METHODS OF JOINING AND MATERIAL DEPOSITION FOR A WORKPIECE WITH A WORKPIECE AREA MADE FROM A TITANIUM-ALUMINIDE ALLOY

(75) Inventors: Ulrike Hecht, Aachen (DE); Victor Vituesevych, Duren (DE); Christian Holzschuh, Alzey (DE)

Correspondence Address: SCHMEISER, OLSEN & WATTS, 22 CENTURY HILL DRIVE, SUITE 302, LATHAM, NY, 12110, US

(73) Assignee: ACCESS E.V., Aachen (DE)

(21) Appl. No.: 12/682,330

(22) PCT Filed: Oct. 10, 2008
(86) PCT No.: PCT/DE08/01636

§ 371 Date: Jul. 8, 2010

(30) Foreign Application Priority Data
Oct. 10, 2007 (DE) 10 2007 048 789.6

(51) Int. Cl. B32B 15/01; B23K 1/20; B23K 31/02

(52) U.S. Cl. 428/615; 228/101; 228/256; 228/248.1; 228/119

(57) ABSTRACT

The invention concerns a method to create fusion-integrated joints of workpieces, in which a workpiece area formed on a workpiece made from a TiAl alloy and a workpiece area formed on another workpiece made from a TiAl alloy or a different high temperature material are joined in a joint area using a joining additive, where the joining additive contains at least one of the elements gallium and indium. The invention also concerns a method to create a material deposit on a workpiece, in which a deposit material is applied to a workpiece area made from a TiAl alloy, where a fusion-integrated joint is produced between the deposit material and the workpiece area, where the deposit material contains at least one of the elements gallium and indium and a filler material.

The invention relates to a method of joining and material deposition for a workpiece with a workpiece area made from a titanium-aluminide alloy.

### BACKGROUND OF THE INVENTION

Titanium-aluminides, abbreviated to TiAl alloys, belong to the group of intermetallic alloys that have been developed based on the TiAl compound with 50 at. % Ti and 50 at. % Al. This phase, also known as γ-TiAl, has a tetragonal crystal structure in which the Ti and Al atoms occupy distinct positions in the crystal lattice. For this reason, the crystal structure of this phase is designated as an ordered substitutional solid solution. The titanium content of various TiAl alloys is typically in the range of 50 to 60% by weight. The following chemical compounds represent typical examples of this alloy class (all details in −atom %): Ti-48AI-2Cr-2Nb, Ti-45Al-5Nb-0.2C-0.2B and Ti-45Al-7Nb-1Mo-0.2B

TiAl alloys can be categorized into gamma alloys, duplex alloys and lamellar alloys according to the phases and structures that can be produced with alloy and process technology. The duplex alloy and lamellar alloys, in addition to the above-mentioned γ-TiAl phase, contain an additional phase called α₂-Ti₃Al.

TiAl alloys are used within the temperature range of about 500° C. to about 900° C.

Titanium alloys can be distinguished from TiAl alloys. The term titanium alloys refers to a class of metallic materials, their main constituent being titanium (100% to 75% weight) and only a smaller proportion (0% to 25% by weight) of additional alloy elements. The following chemical compounds represent typical examples of this alloy class (all details in weight %): Ti-6Al-4V, Ti-6Al-2Sn-4Zr-6Mo and Ti-15Mo-2.7Nb-3Al-0.2Si.

Titanium alloys can be divided into α, β and α+β alloys according to the crystal structure being stabilised by the alloy elements. The fact that these structural variants exist at all is due to the polymorphism of the pure element titanium, which shows a body-centred cubic crystal lattice at temperatures exceeding 882° C. and is called β(Ti) when in this state, while it shows a hexagonal close-packed crystal lattice below 882° C. and is called α(Ti).

Titanium alloys are used at temperatures of up to 500° C. Their strength declines rapidly above such temperatures.

Significant differences between titanium alloys on the one hand and TiAl alloys on the other hand are compared in Table 1.

TABLE 1

| Feature | Titanium alloys | TiAl alloys |
|---|---|---|
| Titanium content | Ti > 75% weight | Ti < 60% weight |
| Aluminium | Al < 10% weight | Al > 25% weight |
| content | | |
| Structural | α (Ti) | γ-TiAl |
| constituents | β(Ti) | γ-TiAl + α₂-Ti₃Al |
| | α(Ti) + β(Ti) | |
| Crystal structures | α(Ti) - hexagonal hP2 | γ-TiAl - tetragonal tP4 |
| (Pearson symbol) | β(Ti) - cubic cI2 | α₂-Ti₃Al - hexagonal hP8 |
| Usable range | up to about 500° C. | about 500 up to about 900° C. |

TiAl alloys on the one hand and titanium alloys on the other are therefore structured from completely different material phases. This decides not only the specific thermophysical and mechanical characteristics but also very differing requirements in terms of the joining techniques used. Titanium alloys are resistant to thermal stresses. In contrast, TiAl alloys are susceptible to thermal stresses due to the brittle-ductile transition at 700° C. to 800° C. (risk of cracking), which is attributable to the characteristics of γ-TiAl. This aspect is particularly important for technological joining methods, for example those involving the formation of cracks during welding. Alternative technological joining methods, for example soldering, are also difficult to apply to TiAl alloys, primarily due to the formation of so-called Heusler phases, namely intermetallic joints of type TiM2Al (with M=Ni, Cu, Au, Pd, Co, etc.), which emerge as brittle phases in the joint area and impair the quality of the soldered joint.

The term ‘joint’ is used to refer to the permanent connection of at least two workpieces or components (DIN 8593) in manufacturing technology. A connection is created locally between the formerly separated workpieces, namely at the joining points, and the shape of the newly-formed component is modified by means of the joint. The connection concerned can be a fixed or pivoting arrangement. The operational forces generated are transmitted through the joint surfaces of the connection. Joining techniques are categorized as (i) joints actuated by adherence (ii) by mechanical interlocking or (iii) fusion-integrated joints (or synonymously: fusion sealed joints or firmly bonded joints). The present application focuses particularly on the fusion-integrated joints, meaning fusion-sealed connections.

Fusion-integrated joints are known as joints in which the linking parts can be bound together by means of atomic or molecular forces. At the same time, they are non-detachable joints, which can only be separated by destroying the joining means. Fusion-integrated joints can be categorised into: soldered joints, welded joints, adhesive joints, vulcanising joints and press-fitted joints. The present application focuses particularly on the fusion-integrated joining processes of soldering and welding.

Soldering refers to a thermal method used to join materials, whereby a fluid phase is formed by melting a solder (melt soldering) or by diffusion at interfaces (diffusion bonding). The solidus temperature of the base materials is not reached (DIN 8505 “soldering”). A non-separable joint actuated by adherence is thus produced by means of soldering. The joint material is usually an easily fusible metallic alloy, the solder. A metallic joint is formed from two metallic workpieces with the help of the solder.

Welding refers to the non-separable joining of components or workpieces with the use of heat or pressure with or without filler metal(s) (DIN ISO 857-1). Fusion welding methods are used particularly frequently for most metallic materials. The joint is formed either as a weld seam or as a spot weld, also in a surface in the case of friction welding, according to the welding method used. The energy required for the welding is supplied from outside.

Titanium aluminide (TiAl materials) are becoming increasingly important as lightweight high temperature materials, for example for the manufacture of engines and gas turbines. The efficiency of conventional internal combustion engines can be increased by using TiAl materials, in that oscillating or rotating masses of individual structural components are reduced. The group of titanium aluminides particularly includes the γ-titanium aluminide.

A TiAl material, for example, is an alloy which, as well as the main alloy element Ti, also contains the following elements: Al (43 to 49), Nb (2 to 10), Mo (0 to 3), Cr (2 to 5), C (0 to 0.3) and B (0 to 0.5).

A reliable and cost-effective joining technology is required to be able to use components made of TiAl alloys in systems such as turbochargers, for example to joint rotors made from TiAl alloys and shafts made from special steels or other high temperature materials such as steel 1.4718 (valve steel), steel 1.4923 (high temperature-resistant steel) or steel 1.7227 (heat-treatable steel) or superalloys such as Inconel (IN718) or Incoloy 909.

Methods such as friction welding, electron beam welding or laser beam welding are proposed for joints between TiAl alloys and similar or dissimilar materials. Hence the use of friction welding in joints with TiAl alloys is known, for example, with reference to documents U.S. Pat. No. 6,291,086 and DE 697 18 713 T2. Welding methods are only suitable to a limited extent, because relatively high thermo-mechanical stresses being induced in the materials to be joined, to which the TiAl materials in particular react sensitively in the temperature range of the so-called brittle-ductile transition (T_{crit}˜600 to 800° C.). The process windows of the above-mentioned welding methods thus are relatively tight, to avoid the formation of stress cracks, and also a complex device is required for the heating and cooling of the workpieces or components to be joined in most cases.

Soldering, in contrast, is a joining method best known for minimising thermo-mechanical stresses and is therefore considered particularly applicable for joints of TiAl materials and TiAl-X-material pairings due to its applied temperature profile,

During soldering, the workpieces to be joined are placed together with a suitable solder in an oven and heated to a temperature that causes the solder to melt. The microstructure of the components or workpieces to be joined does not substantially change. The molten solder wets the components to be joined and penetrates the so-called joint gap, supported by capillary forces, to create a chemical joint between the components to be joined by way of diffusion processes. The fluid constituents of the solder solidify in the weld junction, the so-called soldered joint, during the subsequent cooling process.

The quality of a soldered joint is largely defined by the solder used, being an alloy with a lower melting point than the melting point of material of the two workpieces to be joined and which may be present in the form of powder, wire or foil. The solder must also effectively wet both the materials to be joined when being molten. Elements from the solder must diffuse into both the materials to be joined, to create a chemical joint, without, however, leading to the formation of undesired brittle, intermetallic phases.

A range of commercially available hard solders and special solders for soldering TiAl materials and TiAl-X-material pairings, with melting temperatures higher than 900° C., were examined. These include solders on the basis of nickel, copper, titanium and precious metals such as silver and gold. It emerged, however, that solders based on nickel, copper and gold with TiAl materials react by forming brittle, intermetallic phases of type AlM₂Ti (with M=Ni, Cu, Au, Pd, Co), which are also known as Heusler phases.

Application of diffusion soldering to connect workpieces from TiAl alloys are known from the document DE 698 15 011 T2.

The document DE 697 24 730 T2 relates to the soldering of a turbo wheel produced by a casting technique made from a TiAl alloy and a rotor shaft of heat-resistant steel, the joint of which is manufactured by high frequency induction heating. Solders include all Ag-, Ni-, Cu- and Ti-based alloys, specifically Ag-33Cu-4Ti, Ag-35.5Cu-1.7Ti, Cu-1Co-31.5Mn, Ti-15Ni-15Cu and BNi-3 (all details in weight %) in general terms. The known method is described in detail and the formation of individual phases in the joining zone is described in detail in a technical report by Noda et al. (Noda et al., ‘Joining of TiAl and steel by induction brazing’, Materials Science and Engineering, A239-240. pp. 613-618, 1997). The solder Ag-35.2Cu-1.8Ti is considered to be more suitable in comparison to the solder Ti-15Ni-15 Cu.

A bonding method and the materials required for it, that will allow the diffusion soldering of TiAl workpieces and are suited for making repairs to TiAl workpieces are described in the document EP 0 904 881 B1. The solder paste required for diffusion soldering and repair soldering is characterised by a homogenous powder mixture, consisting of powder A, powder B and an organic binder. Powder A made from a TiAl alloy is mixed with powder B made from a Ti or Cu alloy and stirred with the organic binder into a spreadable mass. This mass is applied to the parts of the workpieces to be joined and the whole arrangement is put into a vacuum oven at a temperature of 1000° C. to 1300° C. for a few minutes. The chemical composition of the two powders A and B is specified as A: Ti—Al—Cr—Nb with 46 to 50 at. % Al and B: Ti—Cu—Ni with 10-15 wt. % Cu and 10 to 15 wt. % (weight %) Ni.

A method for diffusion sintering for the joint of a turbo wheel of TiAl with a shaft of steel is described in EP 1 507 062 A2. Unlike diffusion soldering, only one component in powder form is mixed with a suitable organic binder, and applied into the joint gap here. This particularly concerns a fine-grained powder made from a TiAl-alloy. The diffusion sintering takes place at temperatures from 1200° C. to 1430° C. over a period of 45 minutes to 2 hours.

A range of Ag—Pd—Ga solders for the soldering of titanium materials, for example Ti-6Al-4V, the composition of which includes the element palladium (Pd), with portions of 1 to 20% weight, as well as the element gallium (Ga), with portions of 3 to 10% weight as well as the main constituent silver (Ag), is published In the document U.S. Pat. No. 3,702,763.

### SUMMARY OF THE INVENTION

The object of the invention is to establish a method to create fusion-integrated joints of workpieces and a method for material deposition on a workpiece particularly suited for workpiece areas made from a TiAl alloy.

This object of the present invention is implemented in the form of a method to create fusion-integrated joints of workpieces in accordance with the independent claim 1 and a method of depositing material onto a workpiece in accordance with the independent claim 2. Moreover, the use of the method in accordance with claims 13 and 14 is planned. In addition, a joined workpiece is created in accordance with the independent claim 15. Advantageous arrangements of the invention are the subject of dependent subclaims.

In accordance with one aspect of the invention, where a method to create fusion-integrated joints of workpieces is created in a workpiece area formed on a workpiece made from a TiAl alloy and a workpiece area made from a TiAl alloy formed on another workpiece, or on a workpiece made from a high temperature material different from a TiAl alloy, are joined in a joint area by using a joining additive, where the joining additive contains at least one of the elements gallium and indium.

In accordance with a further aspect of the invention, a method to create a material deposit onto a workpiece is described, where a deposit material is attached to a workpiece area made from a TiAl alloy, while a fusion-integrated joint is produced between the deposit material and the workpiece area, where the deposit material contains at least one of the elements of gallium and indium and a filler.

It was found that joining additives containing gallium and indium, the melting point of which should preferably be in the temperature range of about 900° C. up to about 1300° C., prove particularly suitable for the production of a fusion-integrated joint of TiAl alloys with similar or dissimilar materials, because these elements can penetrate into the microstructure of a TiAl alloy, both into γ-TiAl and α₂-Ti₃Al and can substitute the Al atoms in these phases, without altering their crystalline structure. An excellent ability to wet the workpiece areas of TiAl alloys was also discovered for joining additives or deposit materials containing gallium or indium.

The advantageous embodiments of the method with respect to fusion-integrated joints will be explained in the following section.

A preferred further embodiment of the method for fusion-integrated joints comprises that the workpiece area formed on one workpiece and the workpiece area formed on another workpiece are joined in a fusion-integrated manner by soldering, where a solder is used as a joining additive.

There may be provision for a workpiece area formed on a workpiece and the workpiece area formed on the other workpiece to be joined by welding in a fusion-integrated manner, where a weld metal is used as a joining additive, in a practical arrangement of the method for fusion-integrated joints. The welding method used for this arrangement will preferably be friction welding.

A preferred further embodiment of the method for fusion-integrated joints provides that the joining additive be used in the form of a type of additive selected from the following group of additives: wire, foil, ribbon, powder, paste and coating.

A specialisation of the method for fusion-integrated joints preferably provides that a binary silver-gallium alloy is used as a joining additive.

In an advantageous embodiment of the method for fusion-integrated joints, there can be provision that the workpiece on which a workpiece area is formed from TiAl alloy is joined in a fusion-integrated manner to another workpiece being formed from another high temperature material being different from the TiAl alloy and being selected from the following group of high temperature materials: steel, superalloys, titanium alloys and intermetallic joints.

The advantageous embodiments of the method for material deposition will be explained in the following.

A further embodiment of the method of depositing material may comprises that a fusion-integrated joint is made between the deposit material and the workpiece area by soldering. The soldering may in particular be diffusion soldering.

A preferred further embodiment of the method of depositing material comprises that the fusion-integrated joint between the deposit material and the workpiece area is produced by welding. The welding will preferably be carried out as deposition welding/build-up welding.

There may be provision for the deposit material to be used in the form of a powder or of a paste in a practical embodiment of the method of depositing the material.

An advantageous embodiment of the method of depositing material provides that the filler material contains a powdery filler material.

A preferred embodiment of the method for material application provides that a powder made from a TiAl alloy is used as a powder filler material.

The described method may preferably be used in specific applications. The method to create fusion-integrated joints can be used practically to join system components selected from the following group of systems in a fusion-integrated manner: turbochargers and turbines. The method of depositing material can be used for processing in a production process or to repair a system component selected from the following group of systems: turbochargers and turbines.

A workpiece bond shall preferably be producible using the method for fusion-integrated joints, where a fusion-integrated joining connection is formed between a workpiece area formed on a workpiece made from a TiAl alloy and a workpiece area formed on another workpiece made from a TiAl alloy or a different high temperature material in a joint area by using a joining additive containing at least one of the elements gallium and indium. In a further development of the workpiece bond there may be provision that the workpiece and the other workpiece are system components selected from the following group of systems: turbochargers and turbines.

A workpiece with a workpiece area made from a TiAl alloy can preferably be repaired using the method of applying material, by using a deposit material for a material deposit containing at least one of the elements gallium and indium and a filler material. The workpiece is designed in a practical further development as a system component selected from the following group of systems: turbochargers and turbines.

### DESCRIPTION OF PREFERRED EMBODIMENTS

The invention will be explained in more detail in the following section, with the use of the embodiments, referring to illustrated figures. The figures show:

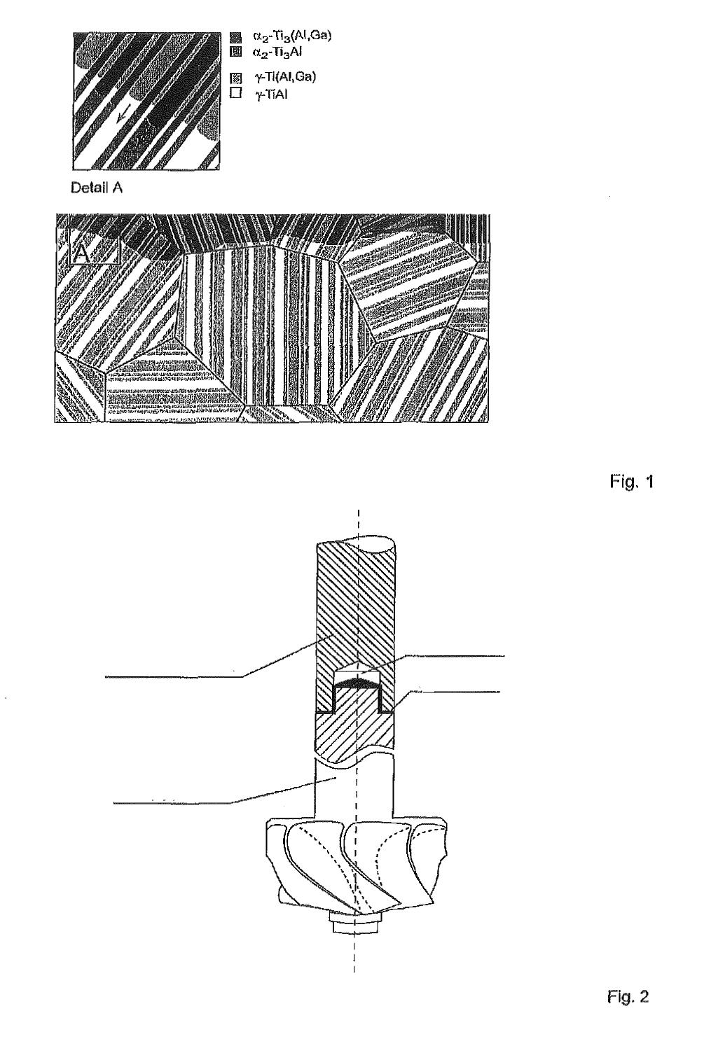

FIG. 1A schematic illustration of a material structure for a joined workpiece area of TiAl and steel

FIG. 2 An arrangement with a turbo wheel and a turbo shaft.

A joining additive containing at least one of the elements gallium and indium is specified in a method to create fusion-integrated joints of workpieces with a workpiece area made from a TiAl alloy. A deposit material containing at least one of the elements gallium and indium, as well as a filler material, is specified for a method of depositing material onto a workpiece with a workpiece area made from a TiAl alloy.

Gallium and indium can be added by alloying to various support elements “T”, where the support elements are Ag, Cu, Ni, Ti or any other alloys with melting points in the temperature range of about 900° C. up to about 1300° C. Gallium and/or indium are appropriate for the construction of a fusion-integrated joint between workpieces of TiAl or of TiAl and other materials, particularly of a different high temperature material, where ‘T-Ga’, ‘T-In’ or ‘T-Ga/In’ alloys are used as joining additive or deposit material. The deposition of the materials comprising the materials proposed here can be carried out by means of methods, which are known as such in various versions

It was found that gallium proved exceptionally well-suited for this purpose. The intermetallic compounds of Ga, such as TiGa and Ti₃Ga, known as titanium gallides, are isomorphous with the stoichiometrically equivalent TiAl and Ti₃Al titanium aluminides, namely they reveal the same atomic construction of the crystal lattice and similar lattice constants: TiAl and TiGa-tetragonal grid (Pearson Symbol tP4) and Ti₃Al and Ti₃Ga-hexagonal grid (Pearson Symbol hP8).

A continuous series of solid solutions from TiAl-TiGa and Ti₃Al—Ti₃Ga, that can be formed as Ti(Al, Ga) and Ti₃(AI, Ga), arises in this way. In addition, Ga exclusively substitutes Al on the lattice positions of the respective intermetallic compounds and thus does not compete with niobium atoms that substitute Ti exclusively. This is a major reason why gallium is well-suited as an active element for technical joining tasks with modern niobium-rich TiAl alloys consisting of up to about 10 at. % niobium.

Gallium also shows a remarkably high level of solubility in iron and nickel and thus serves to ensure that other materials (steels and Ni-based superalloys) to be joined with TiAl are penetrated equally well.

Connecting joints that have been produced with gallium-containing joining additive, for example an intermediate layer or a solder, which can also be considered a filler material, show advantageous features due to the characteristics of gallium. The crystalline structure of the materials to be joined is not severely impaired; in particular, the lamellar microstructure of the TiAl-workpiece areas remains intact (see FIG. 1).

In accordance with one sample version, a precision-cast turbo wheel 1 made from a TiAl alloy is soldered with a shaft 2 of a heat-treatable steel (see FIG. 2), where the solder used is a binary Ag—Ga alloy with from about 5 wt. % (weight %) up to about 10 wt. % gallium. The solder is prepared in the form of a thin strip, the production of which involves the following steps:
a) A suitable amount of silver is melted in a ceramic crucible and superheated to 10 to 50

K above its melting temperature. A suitable amount of solid gallium is introduced to the molten silver, so that the ratio between the weight of the gallium and the weight of the silver is about 5:95 or about 10:90. The solid gallium dissolves completely in the liquid silver during a brief holding time at a temperature of around 950 up to around 1050° C. resulting in an a homogenous Ag—Ga melt.
b) The homogenous Ag—Ga melt is cast in a cold metallic mould representing a plate or rod-shaped cavity and solidifies into a plate or rod-shaped input material.
c) This input material is rolled into a strip, so that the thickness of the strip is in the range of about 50 μm up to about 100 μm and the width of the strip is in the range of about 1 cm up to about 3 cm. Several meters of strip can be produced in this way, using the input material produced in step b). The strip is then available as a soldering material for further technical joining steps.

The workpieces to be soldered are prepared as follows:
d) The turbo wheel 1 at its base has a cylindrical shape. The shaft 2 is provided with a corresponding cylindrical hole, where the dimensions of the cylindrical shape on the one hand and the hole on the other are designed so that a relatively tightly-fitting plug connection can be formed. Here, a radial clearance Δr is achieved, which can be calculated as the difference between the radius of the hole and the radius of the cylindrical shape, and takes values from about 0.05 mm up to about 0.2 mm. The depth of the hole in shaft 2 is from about 1 up to about 3 mm larger than the height of the cylindrical shape at the base of the turbo wheel 1. A small cavity 3 (see FIG. 2), that can be used as the solder reservoir arises at the assembly because of this difference between depth and height.

The workpieces thus prepared are cleaned and pieces of the strip are cut to size and placed in the hole of shaft 2. Alternatively, circular pieces can be punched out of the strip and placed on a front side of the cylindrical shape on turbo wheel 1. Then, the turbo wheel 1 and the shaft 2 can be inserted into each other.
e) The construction prepared in step d) is placed in a vacuum oven (10⁻³ to 10⁻⁵ bar) and brought to a temperature between 950° C. and 1050° C. The solder melts and wets both workpiece areas to be joined at this temperature. The molten solder penetrates the gap created by the radial clearance Δr, because of capillary forces. The formation of the fusion-integrated joint in a joint area 4 (see FIG. 2) takes place, where the active element of the solder, namely gallium, penetrates the materials to be joined and fixes them firmly together while substitute solid solutions are formed during a period of a few minutes, for example 5 to 10 minutes.

Finally, the oven is cooled and the workpieces now firmly joined by soldering are ready for further processing steps.

The features of the invention revealed in the above description, the claims and the drawings may be significant both individually and combined in any way for the realisation of the invention in its various versions.

1. A method for creating fusion-integrated joints of workpieces in which a first workpiece area formed on a first workpiece made from a TiAl alloy and a second workpiece area formed on a second workpiece made in a joint area from a TiAl alloy or a different high temperature material are joined by using a joining additive, where the joining additive contains at least one of the elements gallium and indium.

2. A method of depositing material on a workpiece, in which a deposit material is deposited onto a workpiece area made from a TiAl alloy, where a fusion-integrated joint is produced between the deposit material and the workpiece area, where the deposit material contains at least one of the elements gallium and indium and a filler material.

3. A method in accordance with claim 1, wherein the first workpiece area formed on the first workpiece and the second workpiece area formed on the second workpiece are joined in a fusion-integrated manner by means of soldering, where a solder is used as the joining additive.

4. A method in accordance with claim 1, wherein the first workpiece area formed on the first workpiece and the second workpiece area formed on the second workpiece are joined by welding in a fusion-integrated manner, where a weld additive is used as the joining additive.

5. Method in accordance with claim 1, wherein the joining additive used is in the form of a type of additive selected from the following group of additives consisting of: wire, foil, ribbon, powder, paste and coating.

6. Method in accordance with claim 1, wherein a binary silver-gallium alloy is used as the joining additive.

7. A method in accordance with claim 1, wherein the first workpiece area on which the first workpiece is formed from the TiAl alloy is joined in a fusion-integrated manner to the second workpiece area formed on the second workpiece made of a different high temperature material selected from the following group of high temperature materials consisting of: steel, superalloys, titanium alloys and intermetallic compounds.

8. A method in accordance with claim 2, wherein the fusion-integrated joint between the application material and the workpiece area is produced by soldering.

9. A method in accordance with claim 2, wherein the fusion-integrated joint between the deposit material and the workpiece area is produced by welding.

10. Method in accordance with claim 2, wherein the deposit material is used in the form of a powder or paste.

11. A method in accordance with claim 2, wherein the filler material contains a powdery filler material.

12. A method in accordance with claim 11, wherein a powder made from a TiAl alloy is used as a powdery filler material.

13. The use of a method in accordance with claim 2 for fusion-integrated joints of system components selected from the following group of systems consisting of: turbochargers and turbines.

14. The use of a method in accordance with claim 2 for processing in a production process or the repair of a system component selected from the following group of systems consisting of: turbochargers and turbines.

15. A workpiece bond, produced in accordance with a method of claim 1, in which a fusion-integrated joining connection is formed between a first workpiece area formed on a first workpiece made from a TiAl alloy and a second workpiece area formed on a second workpiece made from a TiAl alloy or a different high temperature material in a joint area by using a joining additive containing at least one of the elements gallium and indium.

16. The workpiece bond in accordance with claim 15, characterised by the fact that the first workpiece and the second workpiece are system components selected from the following group of systems consisting of: turbochargers and turbines.

17. A workpiece that is processed in accordance with a method to create a material deposit in accordance with claim 2, with a workpiece area made from a TiAl alloy, on which the material deposit is formed from a deposit material containing at least one of the elements gallium and indium and a filler material.

18. The workpiece in accordance with claim 17, designed as a system component selected from the following group of systems consisting of: turbochargers and turbines.
